(19) United States
(12) Patent Application Publication
(10) Pub. No.: US 2021/0295444 A1
(43) Pub. Date: Sep. 23, 2021

(54) SYSTEMS AND METHODS FOR INSURANCE AGENCY PLANNING AND MANAGEMENT

(71) Applicant: STATE FARM MUTUAL AUTOMOBILE INSURANCE COMPANY, Bloomington, IL (US)

(72) Inventors: Erick Hossley, Johns Creek, GA (US); Lawrence Paul English, Bloomington, IL (US); Andrew J. Wittman, Bloomington, IL (US); Barbara Denise Keith, Gold Canyon, AZ (US); Ryan Pankey, Bloomington, IL (US); Tiffany Lynn Cooper, Washington, IL (US); Sebastian Escobar, Chicago, IL (US)

(21) Appl. No.: 16/441,942

(22) Filed: Jun. 14, 2019

(51) Int. Cl. G06Q 40/08; G06Q 10/06

(52) U.S. Cl. CPC G06Q 40/08; G06Q 10/0637

(57) ABSTRACT

A system and method allows an insurance agent to plan and manage business goals related to his or her business. After receiving a business goal from the insurance agent, the system and method automatically identifies a set of activities that needs to be carried out by the insurance agent in order to achieve the business goal. The system and method then monitors and tracks actions performed by the insurance agent on the set of activities. Based on the actions performed, the systems and method determines a performance trend that indicates whether or not the business goal can be achieved. The system and method may send a message to notify or warn the insurance agent if the performance trend indicates that the business goal cannot be achieved.

### TECHNICAL FIELD

The present application relates generally to insurance and, more specifically, to systems and methods for insurance agency planning and management.

### BACKGROUND

In the insurance industry, the concept of agency or the use of agents is well established. An insurance agent is an individual authorized by an insurance company to act on behalf of the insurance company. Typically, the insurance company provides information and service regarding insurance policies to the insurance agent who in turn sells the insurance policies directly to consumers. Examples of such insurance policies include vehicle insurance, home insurance, life insurance, health insurance, long-term care insurance, and other like products. In this regard, the insurance agent works with the consumers to procure the insurance policies that are of interest to the consumers.

To help generate and maintain business, insurance agents are often concerned with developing business goals, and then identifying necessary activities (e.g., marketing, compensation, retention, etc.) to accomplish those goals. However, many known systems and methods fail to provide an integrated approach in the planning and management of business goals set out by the insurance agents. For example, the insurance agents are often compelled to create different spreadsheets and documents or rely on the use of various standalone software tools to track, monitor and analyze their business goals. As a result, the abilities of the insurance agents to oversee their business can become fraught with inefficiency and ineffectiveness.

### SUMMARY

The features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

A computer-implemented method for insurance agency planning and management may include receiving, by one or more processors executing a processor-implemented instruction module, a business goal from an insurance agent. The method may also automatically identify, by the processor-implemented instruction module, one or more activities necessary to achieve the business goal. Further, the method may track, by the processor-implemented instruction module, actions performed by the insurance agent on each of the one or more activities. Based on the actions performed, the method may determine, by the processor-implemented instruction module, a performance trend that indicates whether the business goal can be achieved. If the performance trend indicates that the business goal cannot be achieved, the method may send, by the processor-implemented instruction module, a message to notify the insurance agent.

A non-transitory computer-readable storage medium may include computer-readable instructions to be executed on one or more processors of a system for insurance agency planning and management. The instructions when executed, may cause the one or more processors to receive, by a processor-implemented instruction module, a business goal from an insurance agent. The instructions when executed, may also cause the one or more processors to automatically identify, by the processor-implemented instruction module, one or more activities necessary to achieve the business goal. Further, the instructions when execute d, may cause the one or more processors to track, by the processor-implemented instruction module, actions performed by the insurance agent on each of the one or more activities. Based on the actions performed, the instructions when execute d, may cause the one or more processors to determine, by the processor-implemented instruction module, a performance trend that indicates whether the business goal can be achieved. If the performance trend indicates that the business goal cannot be achieved, the instructions when executed, may cause the one or more processors to send, by the processor-implemented instruction module, a message to notify the insurance agent.

A computer system for insurance agency planning and management, the system may comprise a database and a server that includes a memory having instructions for execution on one or more processors. The instructions when executed by the one or more processors may cause the server to receive, via a network connection, a business goal from an insurance agent. The instructions when executed by the one or more processors may also cause the server to automatically identify, by the one or more processors executing one or more processor-implemented instruction modules, one or more activities necessary to achieve the business goal. Further, the instructions when executed by the one or more processors may cause the server to store the one or more identified activities in the database. Still further, the instructions when executed by the one or more processors may cause the server to track, by the one or more processors executing one or more processor-implemented instruction modules, actions performed by the insurance agent on each of the one or more activities. Based on the actions performed, the instructions when executed by the one or more processors may cause the server to determine, by the one or more processors executing one or more processor-implemented instruction modules, a performance trend that indicates whether the business goal can be achieved. If the performance trend indicates that the business goal cannot be achieved, the instructions when executed by the one or more processors may cause the server to send, via a network connection, a message to notify the insurance agent.

### BRIEF DESCRIPTION OF THE DRAWINGS

FIG. 1 is a block diagram of an example system for insurance agency planning and management.

FIG. 2 is a block diagram of various computer implemented components of an example insurance agency planning and management system.

FIG. 3 is a flow diagram of an example method for insurance agency planning and management.

FIG. 4 is a block diagram of a computing environment that implements a system and method for insurance agency planning and management.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Generally speaking, the disclosed system allows insurance agents to oversee their business by providing the insurance agents with an integrated tool set that assists them in planning key business goals, identifying necessary activities to accomplish those goals, and monitoring the progress and success of those goals.

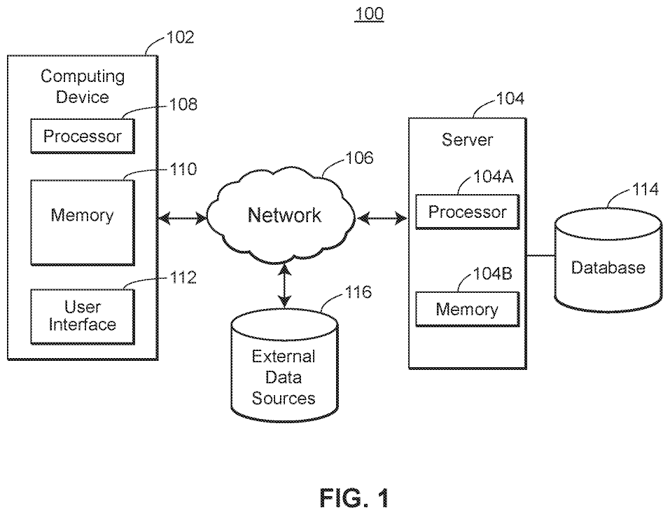

Referring first to FIG. 1, which is a block diagram of an example system 100 for insurance agency planning and management. The example system 100 includes a computing device 102 coupled to a server 104 via a communication network 106 that may include wired and/or wireless links. The computing device 102 may be, for example, a desktop computer, a laptop computer, a tablet computer, a smartphone, or other computing devices capable of sending and receiving data over the network 106. As shown in FIG. 1, the computing device 102 may include a processor 108, a memory 110, and a user interface 112 (e.g., a display screen, a touchscreen, a keyboard, etc.). Moreover, while only one computing device 102 is shown in FIG. 1, the system 100 may include any number of computing devices in other embodiments and/or scenarios.

In operation, an insurance agent may use the computing device 102 to communicate with the server 104 over the network 106 to enter, retrieve, and/or access information during the course of planning and managing business goals related to his or her business. Other users, either employed by or associated with the insurance agent (e.g., a sales team member, an office manager, etc.), may also use the computing device 102 (or another device) to communicate with the server 104 during any of the planning and management stages. In general, the system 100 may be implemented in a web-based client-server architecture that serves multiple users in multiple locations.

The server 104 may be a single server or a plurality of servers with distributed processing. As shown in FIG. 1, the server 104 is coupled to a database 114. In some embodiments, the database 114 may not be directly coupled to the server 104, but instead may be accessible by the server 104 via a network such as the network 106. The database 114 serves as a repository for various data used by the server 104 during the course of planning and managing business goals. Further, the server 104 may communicate, via the network 106, with one or more external data sources 116 (e.g., databases owned or operated by an insurance company). The one or more external data sources 116 may provide relevant data or information (e.g., sales data, demographics data, competitors data, etc.) that may be useful for the purpose of planning and managing business goals.

Generally, the server 104 may be configured to perform various functions associated with planning and managing business goals for the insurance agent. To this end, a processor 104A of the server 104 may execute instructions, routines, programs or modules stored in a memory 1048 of the server 104 to enable the insurance agent and/or other users to perform operations such as defining business goals, tracking and monitoring the progress of business goals, analyzing the outcomes of business goals, etc. In any or all of these cases, programming stored in the memory 1048 and executed on the processor 104A, act as or form parts of an insurance agency planning and management system that enables the insurance agent and/or other users to plan, execute and manage business goals in any of the manners described herein.

In some embodiments, the computing device 102 may be configured to perform the various functions associated with planning and managing business goals for the insurance agent. In this scenario, the processor 108 may execute instructions or programming stored in the memory 110 to enable the insurance agent and/or other users to plan, execute and manage business goals in any of the manners described herein.

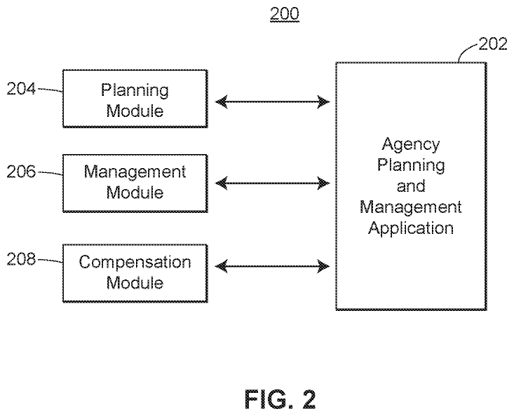

Referring next to FIG. 2, which illustrates various computer implemented components of an example insurance agency planning and management system 200. As shown in FIG. 2, the system 200 includes an agency planning and management application 202 and a plurality of modules 204-208. With reference to FIG. 1, the application 202 and the modules 204-208 may be stored in the memory 104B, and executed by the processor 104A of the server 104.

Generally speaking, the insurance agent and/or other users may use the computing device 102 of FIG. 1 to interact with the agency planning and management application 202. The insurance agent and/or other users may access the application 202 via the user interface 112 of the computing device 102, for example.

The agency planning and management application 202 may process requests from the insurance agent and/or other users to enter, retrieve, and/or access various data and information during the course of planning and managing business goals. As such, the application 202 may communicate with the database 114 and/or the one or more external data sources 116 of FIG. 1. In an embodiment, the application 202 may control the storage, organization and retrieval of data from the database 114.

The insurance agent and/or other users may interact with the application 202 to plan and define one or more business goals. A business goal generally refers to a target for a business to achieve over a specific period of time. For example, the insurance agent may want to expand his or her business, and therefore may specify a goal to increase the total number of insurance policies (e.g., life insurance, vehicle insurance, home insurance, etc.) sold in the next 12 months. A business goal may be divided or defined in terms of one or more sub-goals. Continuing with the above example, to increase the total number of insurance policies sold in the next 12 months, the insurance agent may use seasonality provided by the model for their market area or define a first sub-goal that calls for 100 more policies to be sold in the first 6 months and a second sub-goal that calls for another additional 100 policies to be sold in the remaining 6 months. At any rate, a business goal with multiple sub-goals is completed when each of the sub-goals is completed.

The insurance agent may plan and define business goals for other users. This may be done as a way to assign specific work to individual team members or to properly allocate resources. Of course, the other users may plan and define business goals for themselves. These goals may be approved by the insurance agent and may be rolled up or incorporated into the insurance agent's own goals.

Further, the insurance agent may plan business goals that align with corporate strategy. That is, the goals may be defined so that the goals conform to or follow the business plans set out by the insurance company to which the insurance agent represents. For example, the insurance company may want to start developing business in a new territory. Thus, for the insurance agent, a planned business goal that aligns with the strategy of the insurance company may be one that is geared toward the acquisition of new customers in the new territory.

Moreover, as an insurance company may be represented by multiple agents, goals from different agents may be combined or integrated. For example, goals from all the agents operating in a particular territory may be rolled up or incorporated into a territory plan overseen by a territory sales manager. This allows the territory sales manager to better manage any and all business that occurs in the particular territory. Similarly, territory sales managers may have their own goals which may be rolled up or incorporated into a company sales plan so as to allow the insurance company to better manage business at an enterprise level.

In some scenarios, business goals may be defined to be qualitative in nature. For example, instead of having a goal that specifies numbers to be met (e.g., increasing sales by a certain percentage), a business goal may specify a desire for name recognition such as to enhance the reputation of the insurance agent among existing and potential clients. In some scenarios, the insurance agent and/or other users may define business goals by selecting a goal from a list of established goals.

To perform the function of planning and defining business goals, the application 202 may execute a planning module 204. Once the insurance agent has specified a particular business goal, the planning module 204 may automatically identify one or more activities that are necessary to achieve that particular goal. For example, if the particular business goal is to maintain the insurance agent's business by selling a certain number of insurance policies for an upcoming year, then the planning module 204 may identify a set of activities (e.g., making sales calls, meeting clients in person, delivering presentations, etc.) for the insurance agent to perform so that the goal can be met. In other words, the set of activities include various actions that need to be taken by the insurance agent in order to successfully complete the planned business goal.

The planning module 204 may also identify activities in the set of activities for other users (e.g., an office manager) to perform. Such activities may include, for example, administrative work, accounting work, customer support, etc. Of course, as the other users may plan and define goals for themselves, the planning module 204 may identify activities for the other users to perform based on those goals.

The application 202 may measure the progress being made on a given business goal by executing a management module 206. In particular, for each activity associated with the given business goal, the management module 206 may monitor and track what actions have been taken to complete each activity. For example, an activity may involve scheduling appointments with prospective clients in an effort to achieve the goal of selling more insurance policies. As such, the management module 206 may track how many appointments the insurance agent has scheduled (e.g., by monitoring the insurance agent's calendar). Alternatively or additionally, the management module 208 may track how many new insurance policies have been sold by the insurance agent. In some scenarios, the insurance agent and/or other users may interact with the application 202 to enter data and information that describe what actions have been taken to complete an activity.

By continuously overseeing what actions have been performed for each activity, the management module 206 may determine whether the given business goal is on track of being met or in danger of being missed. For example, a goal may call for the insurance agent to acquire a certain number of new customers. However, if the management module 206 detects that the insurance agent is not carrying out certain actions to complete the activities necessary to achieve that goal (e.g., making calls to potential clients, scheduling appointments, networking, etc.), then the management module 206 may determine that the insurance agent is on a performance trend that will not allow him or her to accomplish the stated goal.

If and when the management module 206 determines that the given business goal is in jeopardy of not being met, the management module 206 may warn the insurance agent of the situation. For example, the management module 206 may send a message (or an alert) to notify the insurance agent of an impending failure to meet the given business goal. Moreover, the management module 206 may help the insurance agent to avoid such impending failure by sending out reminders to remind the insurance agent to carry out certain actions for certain activities if the management module 206 detects a trend showing that the insurance agent is not carrying out those actions.

Further, the management module 206 may determine the success of the given business goal by analyzing how well each activity associated with the goal was performed. For example, the management module 206 may examine how fast each activity was completed or if there were many difficulties encountered when completing each activity. This type of analysis may allow the management module 206 to build up knowledge over time on which activities are most suitable or effective for a given goal. Still further, the management module 206 may accumulate knowledge over time on which goals were effective and successful. This in turn will provide the insurance agent with answers and/or suggestions on whether or not a similar goal in the future will be the right goal for his or her business.

The application 202 may also determine the appropriate compensations for the insurance agent's team members and/or other users. To do so, the application 202 may execute a compensation module 208. Generally, the compensation module 208 may automatically calculate compensations for the insurance agent's team members and/or other users based on various compensation structures. For example, the compensation module 208 may calculate compensation payouts based on how well each activity was completed (activity based), how many new sales were made (production based), how many renewals were secured (renewal based), how well customer service was provided (customer service based), etc. Further, the compensation module 208 may analyze marketing activities and prior compensation payouts to forecast potential compensation payouts based on a desired compensation structure and any marketing activities going forward. Additionally, the compensation module 208 may automatically calculate chargebacks (e.g., return of monies earned) for insurance policies that were prematurely canceled or terminated within a specified period of time.

Moreover, from the above discussions, it can be seen that the systems 100 and 200 may drastically improve the process by which the insurance agent plans and manages business goals for his or her business, at least in part by providing an integrated approach to assist the insurance agent in planning desired business goals, identifying what is needed to accomplish those goals, and monitoring the progress of those goals. For example, by automatically identifying what is needed to accomplish a business goal and tracking the progress of the business goal, resource usage or consumption of the system 100 by the insurance agent and/or other users during the planning and management process may be greatly reduced. Further, the total number of messages or traffic sent over the network 106 during the planning and management process may also be greatly reduced, thereby increasing efficiencies of the network 116.

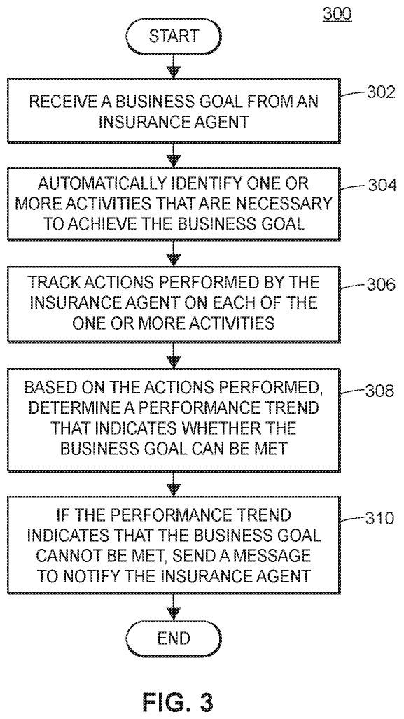

Referring now to FIG. 3, which describes a flow diagram of an example method 300 for insurance agency planning and management. The method 300 may include one or more blocks, routines or functions in the form of computer executable instructions that are stored in a tangible computer-readable medium (e.g., 104B, 110 of FIG. 1) and executed using a processor (e.g., 104A, 108 of FIG. 1).

The method 300 provides the agent with a list of optional goals to select from and begins by receiving the selected business goals from an insurance agent (block 302). The method 300 may receive the business goal via a computing device (e.g., the computing device 102 of FIG. 1) that the insurance agent is operating, for example. The business goal may be related to improving or maintaining the insurance agent's business. As such, the business goal may describe a target for the business to achieve (e.g., acquire new customers, retain existing customers, etc.). The business goal may also be defined to align with the corporate strategies of an insurance company to which the insurance agent represents.

Once the business goal is received, the method 300 automatically identifies one or more activities that are necessary to achieve the business goal (block 304). The one or more activities may specify various actions that the insurance agent need to take in order to successfully complete the business goal. For example, a business goal may entail expanding the insurance agent's business. Thus, the one more activities may include marketing activities (e.g., delivering presentations, networking), sales activities (e.g., making sales calls), networking activities, customer service activities, administrative activities, etc. The method 300 may store the identified one or more activities in a database (e.g., the database 114 of FIG. 1). The method 300 may also communicate the identified one or more activities to the insurance agent with the return on investment expected for each activity, so that the insurance agent is informed of what he or she needs to do. The method 300 may display the one or more activities to the insurance agent via a user interface (e.g., the user interface 112 of FIG. 1), for example.

Next, the method 300 proceeds to track actions performed by the insurance agent on each of the one or more activities (block 306). Here, the method 300 may determine what actions have been taken to complete each of the one or more activities. Continuing with the above example, to achieve the goal of expanding the insurance agent's business, the method 300 may track if sales calls have been made or if appointments have been scheduled. The method 300 may also track actual sales numbers through the sale process (i.e., calls made to prospects, quotes given, applications submitted, etc.)

Based on the actions performed, the method 300 determines a performance trend that indicates whether the business goal can be met (block 308). Here, the method 300 monitors how much progress has been made on achieving the business goal and whether the insurance agent has carried out enough actions to complete each of the one or more activities.

If the performance trend indicates that the business goal cannot or will not be met, the method 300 notifies the insurance agent (block 310). That is, the method 300 makes the insurance agent aware of the situation where the insurance agent is not performing what he or she should be in order to accomplish the stated business goal. The method 300 may notify the insurance agent by sending a message or an alert, for example.

The method 300 may also be implemented with regard to other users either employed by or associated with the insurance agent (e.g., a sales team member, an office manager, etc.). For example, the method 300 may receive a business goal as planned or defined by the other users (block 302). The method 300 may automatically identify any number of activities that are necessary to achieve the business goal from the other users (block 304). The method 300 may also track actions performed by the other users on the identified activities (block 306). Further, the method 300 may determine a performance trend that indicates whether the business goal from the other users can be met based on the actions performed (block 308). Finally, the method 300 may inform the other users if the performance trend indicates that the business goal will not be met (block 310).

In some embodiments, the insurance agent may plan and define goals for the other users. This allows the insurance agent to better manage the performance of his or her team members. In other embodiments, the method 300 may receive goals from the other users and incorporate the goals with the insurance agent's own goals. In any event, the method 300 receives goals, identify activities necessary to accomplish those goals, and proceeds to track and monitor the progress of those goals. In this manner, the method 300 assists the insurance agent to plan and manage any business goals related to his or her business.

Using the systems 100, 200 and the method 300, the planning and management of business goals may be carried out for an insurance agent or agency. However, such systems and method may also be applicable to other industries such as reinsurance businesses, retails, health maintenance organizations, etc.

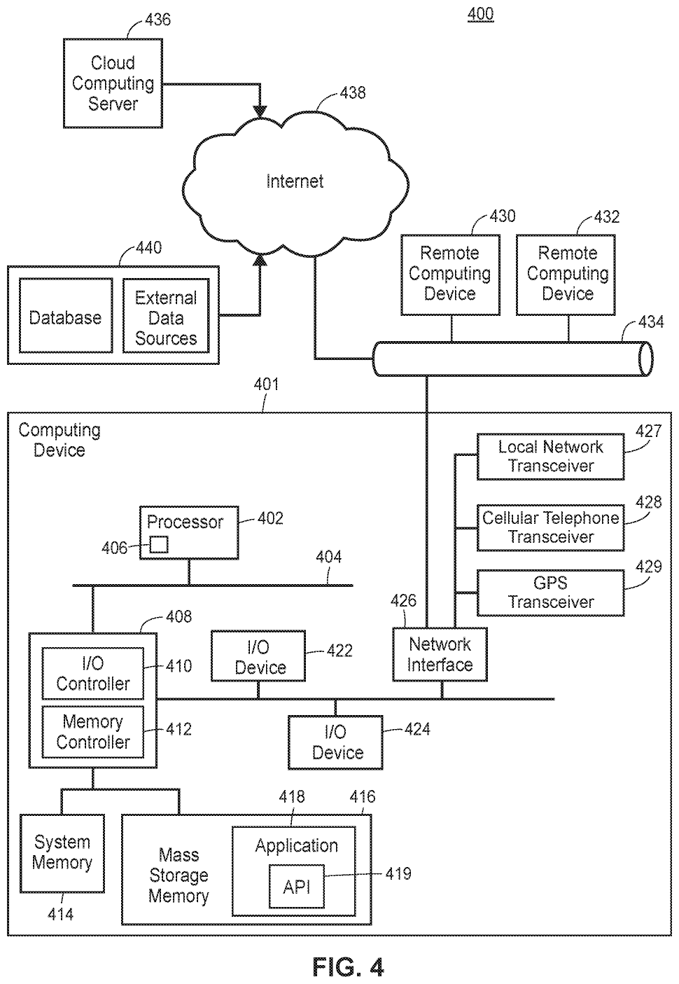

FIG. 4 is a block diagram of an example computing environment for a system 400 having a computing device 401 that may be used to implement the systems and methods described herein. The computing device 401 may be a computing or mobile device (e.g., a desktop computer, a laptop computer, a smart phone, a tablet, a Wi-Fi-enabled device, etc.), a server, or other types of computing or mobile devices. Processor systems similar or identical to the example system 400 may be used to implement and execute the example systems of FIGS. 1 and 2, the method of FIG. 3, and the like. Although the system 400 is described below as including a plurality of peripherals, interfaces, chips, memories, etc., one or more of those elements may be omitted from other example processor systems used to implement and execute the example system 100. Also, other components may be added.

As shown in FIG. 4, the computing device 401 includes a processor 402 that is coupled to an interconnection bus 404. The processor 402 includes a register set or register space 406, which is depicted in FIG. 4 as being entirely on-chip, but which could alternatively be located entirely or partially off-chip and directly coupled to the processor 402 via dedicated electrical connections and/or via the interconnection bus 404. The processor 402 may be any suitable processor, processing unit or microprocessor. Although not shown in FIG. 4, the computing device 401 may be a multi-processor device and, thus, may include one or more additional processors that are identical or similar to the processor 402 and that are communicatively coupled to the interconnection bus 404.

The processor 402 of FIG. 4 is coupled to a chipset 408, which includes a memory controller 410 and a peripheral input/output (I/O) controller 412. As is well known, a chipset typically provides I/O and memory management functions as well as a plurality of general purpose and/or special purpose registers, timers, etc. that are accessible or used by one or more processors coupled to the chipset 408. The memory controller 410 performs functions that enable the processor 402 (or processors if there are multiple processors) to access a system memory 414 and a mass storage memory 416, that may include either or both of an in-memory cache (e.g., a cache within the memory 414) or an on-disk cache (e.g., a cache within the mass storage memory 416).

The system memory 414 may include any desired type of volatile and/or non-volatile memory such as, for example, static random access memory (SRAM), dynamic random access memory (DRAM), flash memory, read-only memory (ROM), etc. The mass storage memory 416 may include any desired type of mass storage device. For example, if the computing device 401 is used to implement an application 418 having an API 419 (including functions and instructions as described by the method 300 of FIG. 3). The mass storage memory 416 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 401 and the system 400. Thus, a module, block, function, operation, procedure, routine, step, and method can be implemented in hardware, firmware, and/or software. In one embodiment, program modules and routines (e.g., the application 418, the API 419, etc.) are stored in mass storage memory 416, loaded into system memory 414, and executed by a processor 402 or can be provided from computer program products that are stored in tangible computer-readable storage mediums (e.g., RAM, hard disk, optical/magnetic media, etc.).

The peripheral I/O controller 410 performs functions that enable the processor 402 to communicate with peripheral input/output (I/O) devices 422 and 424, a network interface 426, a local network transceiver 427, a cellular network transceiver 428, and a GPS transceiver 429 via the network interface 426. The I/O devices 422 and 424 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The cellular telephone transceiver 428 may be resident with the local network transceiver 427. The local network transceiver 427 may include support for a Wi-Fi network, Bluetooth, infrared or other wireless data transmission protocols. In other embodiments, one element may simultaneously support each of the various wireless protocols employed by the computing device 401. For example, a software-defined radio may be able to support multiple protocols via downloadable instructions. In operation, the computing device 401 may be able to periodically poll for visible wireless network transmitters (both cellular and local network) on a periodic basis. Such polling may be possible even while normal wireless traffic is being supported on the computing device 401. The network interface 426 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 412 and the I/O controller 410 are depicted in FIG. 4 as separate functional blocks within the chipset 408, the functions performed by these blocks may be integrated within a single integrated circuit or may be implemented using two or more separate integrated circuits. The system 400 may also implement the application 418 on remote computing devices 430 and 432. The remote computing devices 430 and 432 may communicate with the computing device 401 over an Ethernet link 434. In some embodiments, the application 418 may be retrieved by the computing device 401 from a cloud computing server 436 via the Internet 438. When using the cloud computing server 436, the retrieved application 418 may be programmatically linked with the computing device 401. The application 418 may be a Java® applet executing within a Java® Virtual Machine (JVM) environment resident in the computing device 401 or the remote computing devices 430, 432. The application 418 may also be “plug-ins” adapted to execute in a web-browser located on the computing devices 401, 430, and 432. Further, the application 418 may be adapted to execute in a web-browser using JavaScript. In some embodiments, the application 418 may communicate with a backend component 440 such as the database 114 and the one or more external data sources 116 via the Internet 438.

The system 400 may include but is not limited to any combination of a LAN, a MAN, a WAN, a mobile, a wired or wireless network, a private network, or a virtual private network. Moreover, while only two remote computing devices 430 and 432 are illustrated in FIG. 4 to simplify and clarify the description, it is understood that any number of client computers are supported and can be in communication within the system 400.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” means that a particular element, feature, structure, or characteristic described in connection with the embodiment is included in at least one embodiment. The appearances of the phrase “in some embodiments” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments of a system for insurance agency planning and management for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for insurance agency planning and management through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for insurance agency planning and management, the method comprising:
receiving, by one or more processors executing a processor-implemented instruction module, a business goal from an insurance agent;
querying a database to automatically identify, by the processor-implemented instruction module, one or more activities necessary to achieve the business goal;
tracking, by the processor-implemented instruction module, actions performed by the insurance agent on each of the one or more activities;
based on the actions performed, determining, by the processor-implemented instruction module, a performance trend that indicates whether the business goal can be achieved by determining whether the actions performed include actions needed to achieve the one or more activities;
when the performance trend indicates that the business goal cannot be achieved, sending, by the processor-implemented instruction module, a message to notify the insurance agent that the business goal cannot be achieved;
determining, by the processor-implemented instruction module, effectiveness of the one or more actions towards achieving the business goal; and
updating, by the processor-implemented instruction module, activities necessary to achieve business goals stored in the database based upon the effectiveness.

2. The computer-implemented method of claim 1, further comprising:
receiving, by the processor-implemented instruction module, one or more business goals from other users associated with the insurance agent; and
incorporating, by the processor-implemented instruction module, the one or more business goals received from the other users with the business goal received from the insurance agent.

3. The computer-implemented method of claim 1, wherein the business goal received from the insurance agent includes one or more goals defined by the insurance agent for other users associated with the insurance agent.

4. The computer-implemented method of claim 3, wherein automatically identifying the one or more activities necessary to achieve the business goal includes automatically identifying activities for the other users to perform.

5. The computer-implemented method of claim 4, further comprising tracking, by the processor-implemented instruction module, actions performed by the other users on the activities identified for the other users to perform.

6. The computer-implemented method of claim 1, wherein the one or more activities include one or more of marketing activities, sales activities, networking activities, customer service activities, or administrative activities.

7. A non-transitory computer-readable storage medium including computer-readable instructions to be executed on one or more processors of a system for insurance agency planning and management, the instructions when executed causing the one or more processors to:
receive, by a processor-implemented instruction module, a business goal from an insurance agent;
automatically identify, by the processor-implemented instruction module, one or more activities necessary to achieve the business goal;
track, by the processor-implemented instruction module, actions performed by the insurance agent on each of the one or more activities;
based on the actions performed, determine, by the processor-implemented instruction module, a performance trend that indicates whether the business goal can be achieved by determining whether the actions performed include actions needed to achieve the one or more activities;
when the performance trend indicates that the business goal cannot be achieved, send, by the processor-implemented instruction module, a message to notify the insurance agent that the business goal cannot be achieved;
determine, by the processor-implemented instruction module, effectiveness of the one or more actions towards achieving the business goal; and
update, by the processor-implemented instruction module, activities necessary to achieve business goals stored in the database based upon the effectiveness.

8. The non-transitory computer-readable storage medium of claim 7, further including instructions that, when executed, cause the one or more processors to:
receive, by the processor-implemented instruction module, one or more business goals from other users associated with the insurance agent; and
incorporate, by the processor-implemented instruction module, the one or more business goals received from the other users with the business goal received from the insurance agent.

9. The non-transitory computer-readable storage medium of claim 7, wherein the business goal received from the insurance agent includes one or more goals defined by the insurance agent for other users associated with the insurance agent.

10. The non-transitory computer-readable storage medium of claim 9, wherein the instructions to automatically identify the one or more activities necessary to achieve the business goal include automatically identifying activities for the other users to perform.

11. The non-transitory computer-readable storage medium of claim 10, further including instructions that, when executed, cause the one or more processors to track, by the processor-implemented instruction module, actions performed by the other users on the activities identified for the other users to perform.

12. A computer system for insurance agency planning and management, the system comprising:
a database; and
a server, including a memory having instructions for execution on one or more processors, wherein the instructions, when executed by the one or more processors, cause the server to:
receive, via a network connection, a business goal from an insurance agent;
automatically identify, by the one or more processors executing one or more processor-implemented instruction modules, one or more activities necessary to achieve the business goal;
store the one or more identified activities in the database;
track, by the one or more processors executing one or more processor-implemented instruction modules, actions performed by the insurance agent on each of the one or more activities;
based on the actions performed, determine, by the one or more processors executing one or more processor-implemented instruction modules, a performance trend that indicates whether the business goal can be achieved by determining whether the actions performed include actions needed to achieve the one or more activities;
when the performance trend indicates that the business goal cannot be achieved, send, via a network connection, a message to notify the insurance agent that the business goal cannot be achieved;
determine, by the one or more processors executing one or more processor-implemented instruction modules, effectiveness of the one or more actions towards achieving the business goal; and
update activities necessary to achieve business goals stored in the database based upon the effectiveness.

13. The computer system of claim 12, wherein the instructions of the server, when executed by the one or more processors, further cause the server to:
receive, via a network connection, one or more business goals from other users associated with the insurance agent; and
incorporate, by the one or more processors executing one or more processor-implemented instruction modules, the one or more business goals received from the other users with the business goal received from the insurance agent.

14. The computer system of claim 12, wherein the business goal received from the insurance agent includes one or more goals defined by the insurance agent for other users associated with the insurance agent.

15. The computer system of claim 14, wherein the instructions of the server, when executed by the one or more processors to automatically identify the one or more activities necessary to achieve the business goal include instructions to automatically identify activities for the other users to perform.

16. The computer system of claim 15, wherein the instructions of the server, when executed by the one or more processors, further cause the server to track, by the one or more processors executing one or more processor-implemented instruction modules, actions performed by the other users on the activities identified for the other users to perform.

17. The computer system of claim 12, wherein the one or more activities include one or more of marketing activities, sales activities, networking activities, customer service activities, or administrative activities.
